(19) United States
(12) Patent Application Publication
(10) Pub. No.: US 2012/0286927 A1
(43) Pub. Date: Nov. 15, 2012

(54) Wake Channel Indication for Passive Entry System

(76) Inventor: Andreas Hagl, Dachau (DE)

(21) Appl. No.: 13/468,115

(22) Filed: May 10, 2012

Related U.S. Application Data
(60) Provisional application No. 61/485,439, filed on May 12, 2011.

(51) Int. Cl. G06F 7/04

(52) U.S. Cl. 340/5.61

(57) ABSTRACT

A passive entry system receives an electromagnetic interrogation signal transmitted from an interrogation antenna to a remote transponder, wherein the interrogation signal includes a wakeup pattern data sequence. A plurality of channel signals is generated within the transponder from a corresponding plurality of antennas in response to the electromagnetic interrogation signal. Bit detection is performed on each of the plurality of channel signals to detect the wakeup pattern sequence. A received signal strength indicator (RSSI) of the interrogation signal is determined using the plurality of channel signals, wherein only channel signals on which a valid wakeup pattern sequence is detected are used for determining the RSSI. A wakeup signal is asserted to wake up a processing module in the remote transponder only when the wakeup pattern sequence is detected on at least one of the plurality of channel signals.

### CLAIM OF PRIORITY UNDER 35 U.S.C. 119(e)

The present application claims priority to and incorporates by reference U.S. Provisional Application No. 61/485,439, (attorney docket TI-70861 PS) filed May 12, 2012, entitled “Wake Channel Indication for Advanced Passive Entry System”.

### FIELD OF THE INVENTION

Embodiments of the present invention relate to a passive entry system to prevent unauthorized access to a vehicle, building, or other type of secured location.

### BACKGROUND OF THE INVENTION

Modern motor vehicles are equipped with electronic security systems that prevent unauthorized persons from opening the motor vehicle and starting the engine. In order to open the vehicle and to start the engine, an authorized person must carry a remote control unit in which is stored an identification code group which is transmitted by the remote control unit and which can be checked by a control unit within the vehicle. The control unit in the vehicle will allow access to the vehicle only when this identification code group coincides with the code group expected by it.

Passive entry systems were introduced as a convenience feature for the driver of an automobile to enable access and operation of a vehicle without pressing any buttons. The previous generation remote keyless entry (RKE) system required pushing an “unlock” button on a remote control device to unlock the vehicle's door. Then, a key was required to be inserted in an ignition switch to start the vehicle. For a passive entry system, the driver may simply go with the passive entry device (electronic key) to the vehicle and pull the door handle. Once inside, the driver may simply push a starter button for the engine to operate. There are basically two systems on the market: triggered and polling. Triggered systems have detection switches at the door handles to initiate activation/readings, whereas polling systems perform repeated reads with a repetition rate of about 500 ms, for example.

The control unit in the vehicle transmits an interrogation signal as soon as the person wanting access to the vehicle touches the door handle. The remote control unit, which is carried by the person and which may be located, for example, in the car key, in a key tag or even in a so-called chip card, receives this interrogation signal and subsequently re-transmits the identification code group to the control unit within the vehicle. The control unit then checks this code group for coincidence with the code group expected by it and, on positive verification of coincidence, allows access to the vehicle. The person who touched the door handle can therefore operate the door handle as if the vehicle had not been locked. This is because the interchange of signals between the control unit and the remote control unit takes place in such a short time that no delay is felt during the mechanical opening process of the vehicle. This security system can be complemented by a further security system, or it can be combined with an already existing security system, which only allows the engine to be started after the execution of an individual verification process and positive confirmation. Such an enhanced security system is especially advantageous when the engine is not started by introducing an ignition key into a specifically provided ignition lock, but simply by pressing a starter button. Without the provision of additional security measures against unauthorized starting of the engine of a vehicle equipped in this way, dangerous situations may easily, arise. Assuming that an authorized person has opened the vehicle door, the engine could be started by pressing the starter button without any further security check taking place. If, for example, a child, being in the vehicle after the door has been opened, pressed the starter button, then the engine may start while the person intending to carry out the starting process is not yet in the vehicle. The vehicle could thus move off and cause a dangerous situation.

### BRIEF DESCRIPTION OF THE DRAWINGS

Particular embodiments in accordance with the invention will now be described, by way of example only, and with reference to the accompanying drawings:

FIG. 1 is a block diagram of an exemplary passive entry system deployed on a vehicle;

FIG. 2 is a more detailed block diagram of a passive entry system;

FIG. 3 is a plot illustrating magnetic field strength vs. distance;

FIG. 4 is a diagram illustrating antenna arrangement on the passive entry device of FIG. 1;

FIG. 5 is a more detailed block diagram of the analog front end portion of the passive entry device of FIG. 1;

FIG. 6 is a plot illustrating an example of noise received on three channels of a passive entry device; and

FIG. 7 is a flow diagram illustrating operation of a passive entry system.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

An embodiment of the invention relates to a security system to prevent unauthorized starting of the engine of a vehicle. A remote control unit contains a transponder which, on reception of an interrogation signal by means of a set of reception aerials, transmits an identification code group by means of a transmitter unit. A control unit located in the vehicle which, on actuation of a starter button within the vehicle, transmits the interrogation signal, and subsequently checks the identification code group transmitted by the remote control unit and enables the starting procedure of the engine only when the identification code group coincides with the code group expected by it. A received signal strength indicator (RSSI) of the interrogation signal is determined by the remote control unit using the plurality of channel signals, wherein only channel signals on which a valid wake pattern sequence is detected are used for determining the RSSI. In this manner, it can be reliably determined that the remote control unit is located within the vehicle, and therefore it can be assumed the intended driver is also within the vehicle.

RSSI (Received Signal Strength Indicator) measurement is used in passive entry systems to determine the location of a key. Modern systems use three independent channels for improved operation in a noisy environment. When one channel is interfered with by noise, the other channels may still receive a valid wake pattern. A typical prior art device indicates that a valid wake pattern (e.g. 16 bit of data) is received only by one of the channels. Afterwards the RSSI signals of all three channels are measured to determine the location of the key or to determine the distance of the key to the interrogator antenna. Therefore, a prior art system could erroneously interpret a channel, interfered with by noise, as channel with near distance.

To overcome this potential noise issue, an embodiment of the present invention checks all three channels for receipt of a valid wake pattern. Only channels that received a valid wake pattern are used to determine the location of the key via RSSI signals.

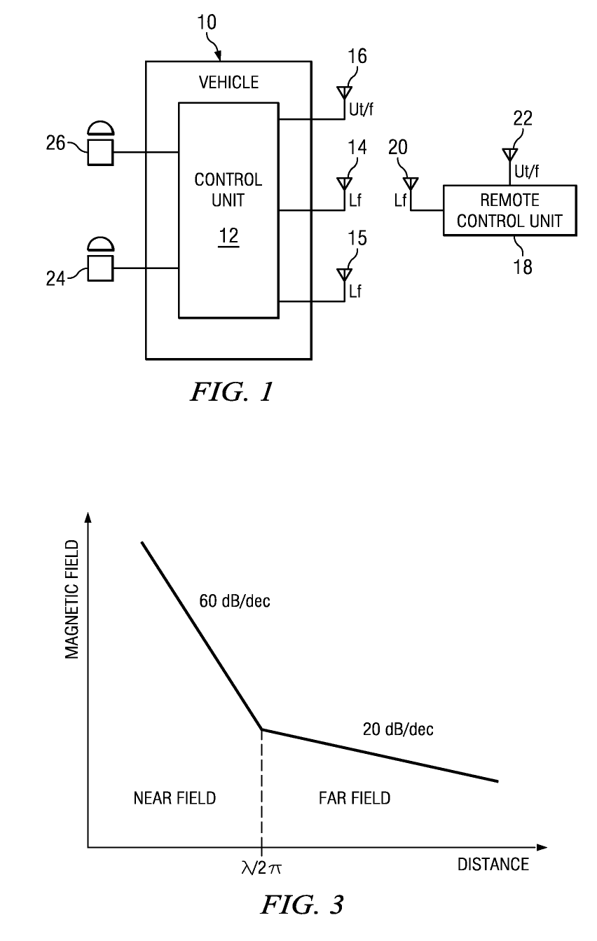

FIG. 1 is a block diagram of an exemplary passive entry system deployed on a vehicle. The passive entry system is described in the context of an automotive application; however, in other embodiments, a passive entry system as described herein may be used to control access to other types of vehicles such as a motorbike or truck, for example. In other embodiments, a passive entry system as described herein may be used to control access to stationary pieces of equipment, control panels, homes, offices and other types of buildings, and to other types of secure locations, for example.

For a passive entry system, the driver may simply go with the passive entry device (electronic key) to the vehicle and pull the door handle. Once inside, the driver may simply push a starter button for the engine to operate. There are basically two systems on the market: triggered and polling. Triggered systems have detection switches at the door handles to initiate activation/readings, whereas polling systems perform repeated reads with a repetition rate of about 500 ms, for example.

Systems such as these require a precise detection of the key location—it is essential to determine if a key is inside or outside the vehicle. Starting the engine should only be possible if the passive entry device is inside the vehicle and exit locking of the vehicle should only occur if the key is outside the vehicle.

Vehicle 10, represented in block form in FIG. 1, may be configured in such a way that only authorized persons are be allowed access to the vehicle; that is, to be allowed to open the door. Vehicle 10 contains a control unit 12 from which checking, transmission and reception functions are carried out. Two types of aerials are used for this purpose; typically there are several low frequency (LF) transmitting aerials 14, 15 and one ultra high frequency (UHF) reception aerial 16

Assigned to the vehicle 10 is a remote control unit 18, which is normally carried by the authorized person and which also has two types aerials; LF reception aerial 20 and UHF transmitting aerial 22. In this embodiment, LF aerial 20 includes three orthogonally arranged antennas. The remote control unit 18 can generate an identification code group which is unequivocally assigned to the vehicle 10 and its control unit 12, so that only the person carrying this remote control unit 18 can gain access to the vehicle.

By actuating a driver's door switch 24, symbolically represented as a push button, the control unit 12 can be made to transmit an interrogation signal via LF transmitting aerial 14 located in or near the driver's door. The switch 24 is typically connected to the door handle of the vehicle, so that it will be actuated automatically when the door handle is touched and moved. Aerial 14 is typically located near the door handle. The interrogation signal transmitted by the control unit is received by the remote control unit 18, which is carried by the person actuating the door handle. Reception of the interrogation signal causes the remote control unit 18 to generate and transmit, via the UHF transmitting aerial, an identification code group which is received by the UHF reception aerial 16 of the control unit 12. If this code group coincides with a code group expected by the control unit 12, the control unit causes the door to unlock, so that the person gripping the door handle will also be able to open the vehicle door.

The existence of the entry-access security system is not an absolute precondition for the security system for the prevention of unauthorized starting of the engine of a vehicle, to be described in the following, since the latter can also be used when the authorized person has opened the door of the vehicle in the conventional way by means of a key, without a code check having taken place. The security system to be described in the following, however, complements the access system mentioned above in an advantageous way, so that it will now be described as operating in conjunction with the access security system.

Typically, once the driver is in the driver's seat, actuation of starter button 26 causes the control unit 12 to transmit an interrogation signal via another LF transmitting aerial 15, which is received at the reception aerial 20. Engine start aerial 15 is typically located inside the vehicle compartment, such as in a console between the driver's seat and a passenger seat or in the dash-board between the driver's seat and passenger's seat, or near the start button, for example.

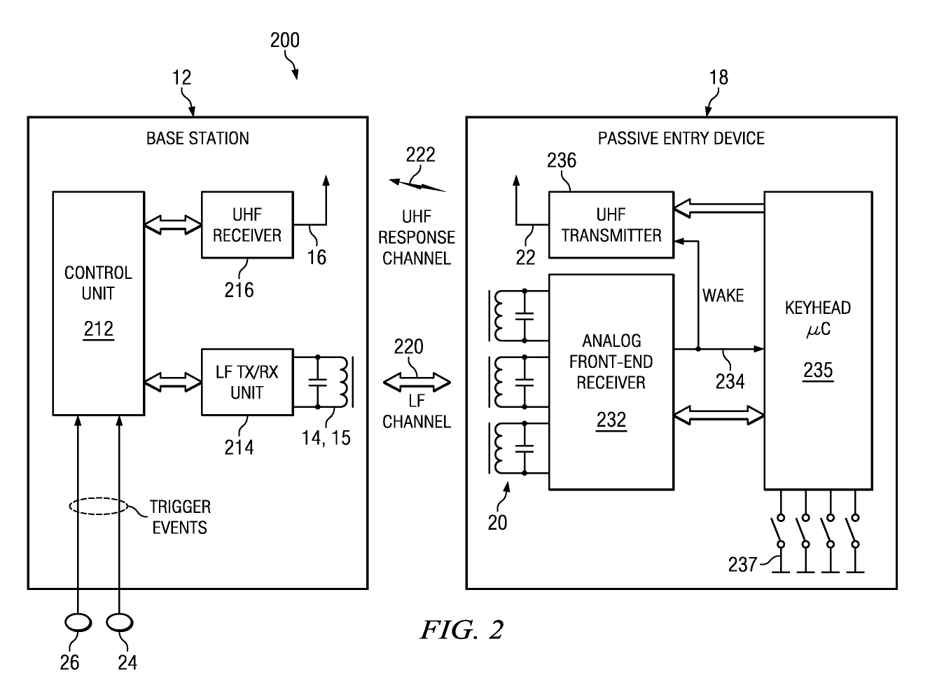

FIG. 2 is a more detailed block diagram of a passive entry system 200 that may be used in FIG. 1. Base station 12 includes control unit 212, LF transceiver unit 214, and UHF receiver 216. LF transmitter 214 may coupled to several LF antennas 14, 15, for example. Typically, an automobile may have several different access LF antennas 14 in the driver's door, passenger's door, near the trunk and/or back bumper, etc for sensing key presence in response to access requests initiated by nearby door handle buttons 24, and have one or more engine start antenna 15 located in the interior of the automobile for sensing key presence in response to engine start requests initiated by pushing start button 26.

Remote entry device 18 includes analog front end 232, controller 235, and UHF transmitter 236. Front end unit 232 is coupled to three orthogonally arranged antennas 20. UHF transmitter 236 is coupled to UHF antenna 22. In order to conserve battery power, controller 235 and transmitter 236 are placed in a low power mode most of the time. When front end receiver 232 senses a low frequency transmission channel 220 received via antenna 20, it processes the received signal and attempts to decode an identification sequence within the received signal. If an expected identification sequence is decoded, it then asserts wakeup signal 234 that is coupled to controller 235 and transmitter 236 and thereby causes them to turn on. As described above, an identification group will then be transmitted from passive entry device 18 to base station 12 via UHF channel 222.

Remote device 18 may include one or more switches 237 that may initiate transmission of an identification group to unlock a door. For example, this may be useful to unlock a door or trunk lid when the remote device is too far from the door to operate in the passive mode.

FIG. 3 is a plot illustrating magnetic field strength vs. distance. The characteristics of a magnetic field may be utilized to determine the location of the passive entry. In the near field, the magnetic field strength declines approximately 60 dB per decade, while in the far field it declines approximately 20 dB per decade. Therefore, low frequency magnetic coupling may be used for communication from vehicle to passive entry key. Several low-frequency transmit antennas are located in the vehicle for proper system operation. When receiver antenna 20 is physically near one of the LF transmission antennas 14, 15, an air core magnetic transformer is formed to provide LF channel 220. The distance between an interrogating antenna 14, 15 and the receiver antenna 20 may therefore be estimated based on the amplitude of a signal produced by antenna 20. Within the near field distance, the estimated distance may have a high degree of accuracy.

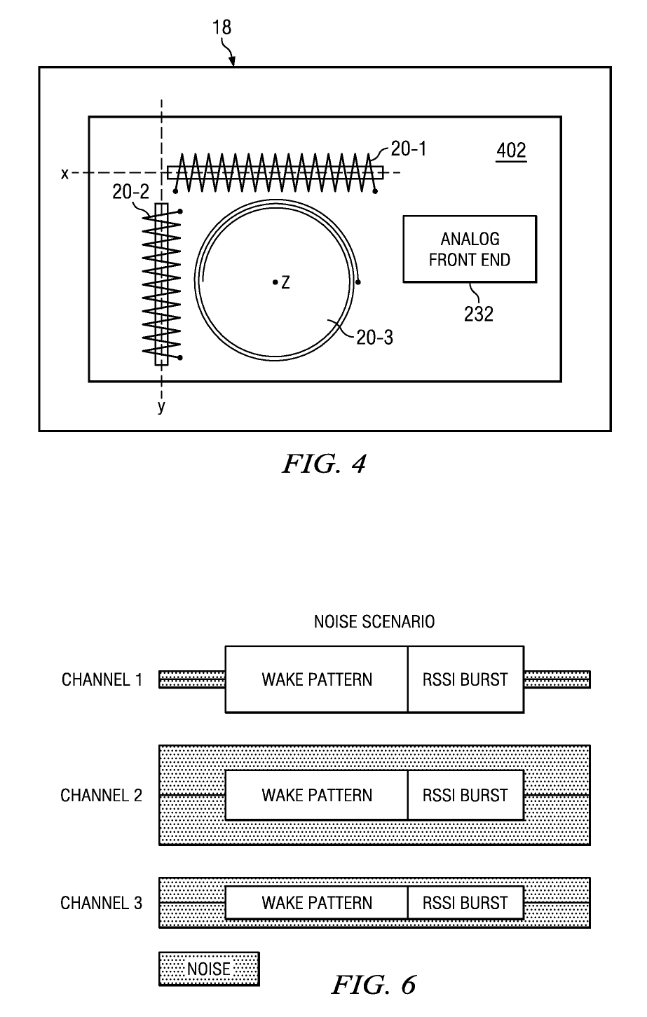

FIG. 4 is a diagram illustrating antenna arrangement on one embodiment of the passive entry device of FIG. 1. Remote control unit 18 contains reception aerials 20-1, 20-2, and 20-3. Three corresponding signal detectors are included within front end unit 232. The three orthogonally situated antennas make it possible to adapt the remote control unit 18 to the spatial reception conditions and, in particular, to the field strength distribution inside the motor vehicle. Aerials 20-1, 20-2, and 20-3 are disposed on substrate 402 of the remote control unit in such a way that their main directions of reception are aligned in three different spatial axes, which are perpendicular to each other. In this manner, even under very unfavorable conditions, at least one of the aerials may be able to receive the interrogation signal at sufficiently high field strength to ensure its reliable evaluation and further processing.

An embodiment of remote device 18 may be a chip card 402. Chip card 402 may be contained within a separate housing s illustrated, or may be simply a stand-alone card. Two aerials 20-1 and 20-2 are embodied as ferrite aerials which are arranged on the chip card in line with the axes denoted x and y, which are perpendicular to each other. The third aerial 20-3 is embodied as an air coil whose turns are in a plane with that of the chip card. The main reception directions of the corresponding aerials are therefore in the direction of line x (aerial 20-1), in the direction of line y (aerial 20-2), and in the direction indicated by the point z perpendicular to the plane of the figure (aerial 20-3). Due to this arrangement of the three reception aerials, the interrogation signal is received in practice at sufficiently high field strength by at least one of the aerials, whatever the position of the remote control unit 18, to enable its evaluation by the code checking circuit.

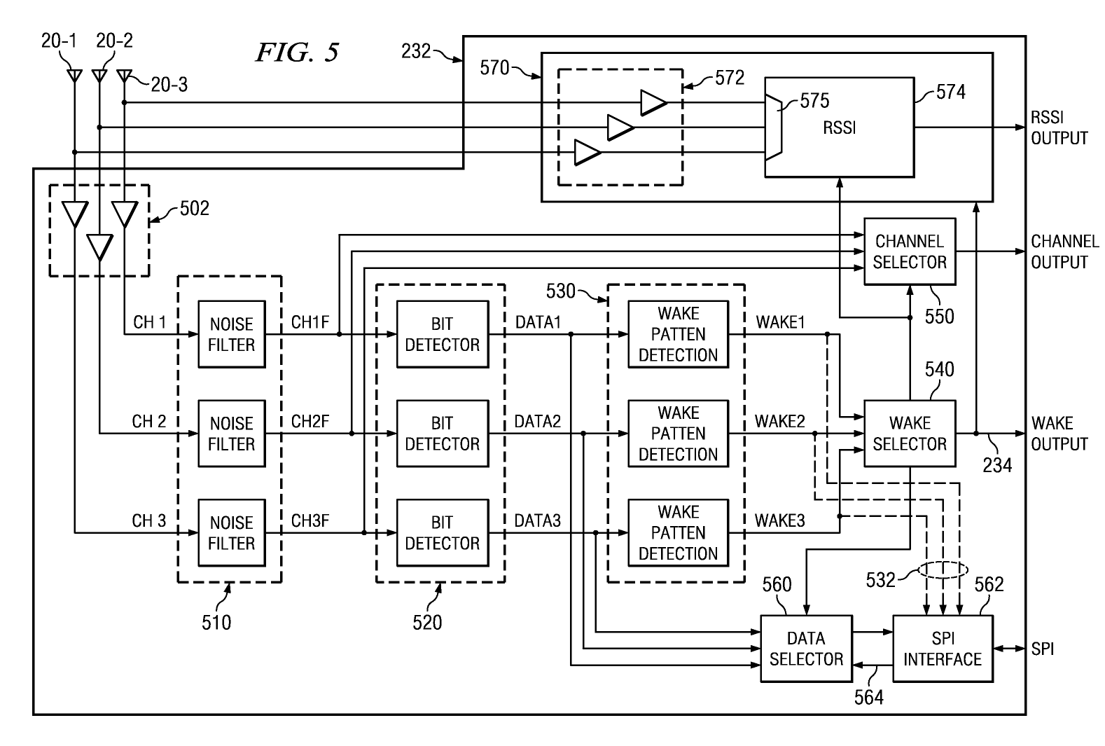

FIG. 5 is a more detailed block diagram of the analog front end 232 of the passive entry device of FIG. 1. Each of the antennas provides a channel signal that is amplified in low noise amplifiers 502 and then connected to a respective noise filter 510. Bit detectors 520 operate in parallel to demodulate each filtered channel signal to produce a sequence of data bits. Wake pattern detectors 530 operate in parallel to look for an expected pattern of data that is defined to be the wake pattern. Wake selection logic 540 keeps track of which channels contain a valid wake pattern. When at least one channel has a valid wake pattern, wake signal 234 is asserted to bring controller 235 and transmitter 236 out of the low power state and into an operating state. In this embodiment, low noise amplifiers 502, noise filters 520, bit detectors 520, wake pattern detectors 530 and wake selection logic 540 are all implemented using low power analog logic. using known techniques. In some embodiments, the standby current draw may be less than 5 microamps, for example, and thereby allows a long battery life.

RSSI module 570 includes low noise amplifiers 572 for each antenna signal and RSSI determination module 574 that measures a signal strength of each amplified antenna signal. In this embodiment, RSSI determination module 574 includes a selector 575 to sequentially select the amplified channel signals. In this manner, no channel to channel difference is introduced by the RSSI determination process. Only channels for which a valid wake pattern was detected are used for determining a received signal strength indicator (RSSI). If a valid wake pattern is not detected in a channel, that channel signal is not used for determining RSSI. In this manner, a channel that may be experiencing a high level of noise that corrupts the channel signal will not be used to produce an erroneous RSSI. An estimated distance between remote unit 18 and an active LF antenna 14, 15 may then be calculated based on the value of the determined RSSI.

Typically, RSSI module 570 is placed in a low power state along with microcontroller 235. When a valid wakeup pattern is detected and wake signal 234 is asserted, RSSI module 570 will be placed into an operation mode and an RSSI will then be determined. This allows low noise amplifiers 570 to be designed to produce a more accurate amplification, which requires more power than used by low noise amplifiers 510. In some embodiments, there may also be a provision, such as a control signal from microcontroller 235, to allow microcontroller 235 to request RSSI updates during operation of microcontroller 235.

Typically, while a driver is approaching a vehicle and after a driver sits in the driver's seat, the orientation of the remote key may be in constant flux. Each time a new interrogation pulse is received, a new determination is made as to which channel a valid wakeup pattern is detected, and thereby which channel to use for RSSI determination. In this manner, as the orientation of the remote key changes and as different channel(s) experience noise interference, the best channel will be selected dynamically while a channel with interference will not be selected.

Channel selector 550 is controlled by wake selector 540 based on detection of valid wake patterns in the three channels. The channel output signal from channel selector 550 may be used by microcontroller 235 for further signal or data processing.

Data selector 560 is also controlled by wake selector 540 to select one channel on which a valid wake signal was detected. This selected channel data signal is then coupled to serial-to-parallel converter 562 and then provided to controller 235 for use in further data transfers from base station 12 to passive device 18. Data selector 560 may also be controlled by a control signal 564 received from microcontroller 235 via SPI 562. This allows microcontroller 235 to select any of the three channels to observe or process data being received on them.

After it is awoken, microcontroller 235 may monitor the output of bit detectors 520, wake pattern detectors 530 via signals 532, and RSSI module 570 to thereby dynamically select a channel that is being received with a lower amount of noise for data communication with base station 12.

FIG. 6 is a plot illustrating an example of noise received on three channels of a passive entry device. Due to difference in orientation of each of the three antennas 20-1, 20-2, 20-3, the signal strength of each of the three channel signals is typically different. In this example, channel 1 has the highest amplitude signal. However, channel 2 is experiencing a large amount of noise that prevents a valid wake pattern from being detected on channel 2. Therefore, channel 2 will be excluded from the RSSI determination since a valid wake pattern was not detected on channel 2.

A situation will now be described where an authorized person has opened the vehicle door, is sitting in the driving seat, and actuates starter button 26 in an attempt to start the engine. FIG. 1 shows starter button 26 schematically in conjunction with the control unit 12. Actuation of starter button 26 causes the control unit 12 to transmit an interrogation signal via engine start LF transmitting aerial 15, which is received at the reception aerial 20. The reception aerial 20 then feeds three channels of interrogation signal received by the three reception aerials 20-1, 20-2, 20-3 to analog front end 232. When the control unit 12 in the vehicle 10 has transmitted the interrogation signal, then, because of the short distance between the engine start LF transmitting aerial 15 and the reception aerial 20, at least one of the bit detectors 521-523 should be able to decode a valid wakeup pattern. Wake selector 540 then records which channels have valid wakeup patterns and causes any channel that does not have a valid wakeup pattern to be ignored while the RSSI is being determined. If the RSSI indicates the location of the remote key is sufficiently close to engine start LF antenna 15, wakeup signal 234 is asserted to a controller 235 and transmitter 236, which switches this from a current-saving quiescent state into an active state, thereby causing a UHF transmitter 236 to transmit via the UHF transmitting aerial 22 an identification code group, unambiguously assigned to the vehicle 10. This code group is received by the control unit 12 in the vehicle 10 via the UHF reception aerial 16 and thereupon enables the starting of the engine, because the checking procedure of the identification code group in the control unit 12 has, in the assumed case, yielded a positive result.

In the case where an unauthorized person, carrying a remote control unit not assigned to the vehicle 10, has taken the driving seat, and has actuated the starter button, the control unit 12 would have recognized the identification code group received as incorrect and, therefore the engine would not be started.

A situation will now be considered where a person authorized to start the engine of the vehicle has opened the vehicle door and is therefore at a relatively short distance from the driver's door LF transmitting aerial 14, but where this person is not yet sitting in the driving seat but remains standing outside the vehicle and is therefore at a relatively long distance from engine start antenna 15. In this example, a child within the vehicle may be pushing the start button.

As in the case previously described, pressing the starter button 26 causes the control unit 12 to transmit the interrogation signal via engine start LF transmitting aerial 15. This interrogation signal may be received by the reception aerial 20 of the remote control unit 18 and evaluated by the front-end logic 232. Since, however, the person carrying the remote control unit 18 is not in the vehicle, but outside the vehicle, the field strength generated by the interrogation signal at the location of the remote control unit 18 will, in this case, not be sufficient to exceed the RSSI threshold level of the signal detector; therefore a wakeup signal will not be asserted to controller 235 and transmitter 236. There will, therefore, be no transmission of the identification code group via the UHF aerial 22. As a consequence, the control unit 12 in the vehicle 10 receives no reply from the remote control unit 18, and therefore does not enable the start of the engine. Pressing the starter button 26 will, therefore, have no effect.

Since in this case the code checking circuit 332 does not deliver a wake-up signal 234 at its output, controller 235 and transmitter 236 remain in its current-saving quiescent state, thus preventing any unnecessary current consumption. This has a beneficial effect on the useful life of the battery in the remote control unit 18.

In some cases, there may be sufficient noise on one or more channel signals provided to front end receiver 232 to produce an RSSI indication that might indicate a short distance. However, since in the case of a large noise signal, it is very unlikely that a valid wakeup pattern will be detected on that noisy channel; therefore that noisy channel will be barred from the RSSI determination. Thus, the RSSI will correctly indicate the remote key is not close to the engine start LF antenna 15 and will not provide a start code to controller unit 12.

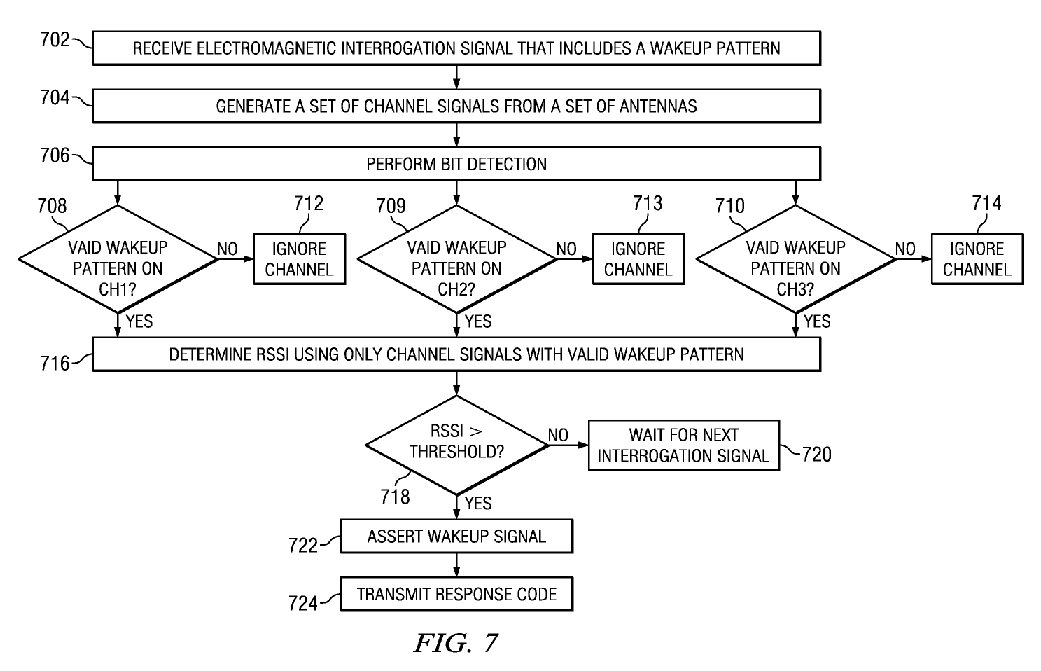

FIG. 7 is a flow diagram illustrating operation of a passive entry system. An electromagnetic interrogation signal from an interrogation antenna is received 702 by a remote transponder. As described above in more detail, the interrogation signal includes a wakeup pattern data sequence. In one embodiment, the interrogation antenna is located in an automobile, and the interrogation signal is transmitted in response to a trigger event in the automobile. As discussed above in more detail, the trigger event may result from pressing a door handle or from pressing an engine start button, for example. In another embodiment, the interrogation antenna may be located in another type of vehicles such as a motorbike or truck, for example. In other embodiments, the interrogation antenna may be located in a stationary piece of equipment, a control panel, a home, an office or in another type of building, or in another types of secure location, for example. In this case, the interrogation signal may be transmitted in response to pushing a button, stepping on a mat, touching a door handle, etc, for example in an attempt to gain entry to a location or to start an action.

A set of antennas that receives the interrogation signal produce 704 a corresponding set of channel signals within the transponder in response to the magnetically coupled electromagnetic interrogation signal.

Bit detection is performed 706 on each of the set of channel signals to demodulate and detect the wake pattern sequence. This may include demodulation and decryption of encrypted signals. The encryption may have done using proprietary or standardized encryption techniques that are known to both the remote key and the base station.

A received signal strength indicator (RSSI) of the interrogation signal is determined 716 using the plurality of channel signals; however, only channel signals on which a valid wake pattern sequence is detected 708-710 are used for determining the RSSI. If a valid wakeup pattern is not detected on channel signal, that channel signal is ignored 712-714.

When the RSSI is greater than a threshold value 718, indicating the remote key is within a desired distance of the interrogation antenna, a wakeup signal is asserted 722 to awaken other control logic within the remote transponder. If the RSSI does not meet or exceed the threshold value, the system waits 720 for the next interrogation signal.

Once the other control logic within the remote transponder is awakened, a response code may be transmitted 724 to the base station, as described in more detail above. In response to the response code, a door may be unlocked, an engine started, etc.

### Other Embodiments

While the invention has been described with reference to illustrative embodiments, this description is not intended to be construed in a limiting sense. Various other embodiments of the invention will be apparent to persons skilled in the art upon reference to this description. For example, while the passive entry system was described in the context of an automotive application, in other embodiments, a passive entry system as described herein may be used to control access to other types of vehicles such as a motorbike or truck, for example. In other embodiments, a passive entry system as described herein may be used to control access to stationary pieces of equipment, control panels, homes, offices and other types of buildings, and to other types of secure locations, for example.

In some embodiments, there may be a provision to overcome a depleted battery. For example, a radio frequency identification (RFID) tag circuit may be provided in the remote key. The RFID scavenges power from an electromagnetic field that is provided by an antenna in a slot or near the start button, for example. The driver has to either put the key in a slot that has the antenna and push the starter button or push the starter button while holding the passive entry key a few centimeters from the starter button.

In some embodiments, access to the vehicle may be provided by a mechanical key lock at the driver door or trunk, for example.

Passive entry systems typically use challenge-response authentication because of the availability of two-way communication.

There are many different encryption methods used. In some embodiments, an encryption method that is proprietary to a car or semiconductor manufacturer may be used. In some embodiments, a standardized encryption method may be used for the remote keyless entry function.

The techniques described in this disclosure may be implemented in hardware, software, firmware, or any combination thereof. For example, an embodiment of the noise filtering, bit detection, and wake pattern detection may be performed by software executed on a digital signal processor. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in analog and digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method of operation for a passive entry system, the method comprising:
receiving an electromagnetic interrogation signal from an interrogation antenna by a remote transponder, wherein the interrogation signal includes a wakeup pattern data sequence;
generating a plurality of channel signals within the remote transponder from a corresponding plurality of antennas in response to the electromagnetic interrogation signal;
performing bit detection on each of the plurality of channel signals to detect the wakeup pattern sequence; and
determining a received signal strength indicator (RSSI) of the interrogation signal using the plurality of channel signals, wherein a channel signal on which a valid wakeup pattern sequence is not detected is not used for determining the RSSI.

2. The method of claim 1, further comprising asserting a wakeup signal to wake up a processing module in the remote transponder only when the wakeup pattern sequence is detected on at least one of the plurality of channel signals.

3. The method of claim 2, further comprising determining a distance between the interrogation antenna and the remote transponder based on the RSSI.

4. The method of claim 2, further comprising transmitting a response code from the remote transponder after the wakeup signal is asserted.

5. The method of claim 1, wherein the plurality of channel signals comprise three channel signals derived from three orthogonally oriented antennas.

6. The method of claim 1, wherein the interrogation antenna is located in an automobile, and wherein the interrogation signal is transmitted in response to a trigger event in the automobile.

7. A remote transponder device for a passive entry system, the remote transponder comprising:
a plurality of low frequency (LF) receiving antennas, each configured to provide a channel signal in response to receiving an interrogation burst;
bit detection logic coupled to receive each channel signal with an output to provide data recovered from each channel signal
pattern detection logic coupled to the bit detection logic, the pattern detection logic configured to detect a wakeup pattern of each channel signal, wherein the wakeup pattern is included in the interrogation burst; and
channel selection logic coupled to receive each channel signal, the selection logic configured to determine a received signal strength indicator (RSSI) of the interrogation signal using the plurality of channel signals, wherein only channel signals on which a valid wakeup pattern sequence is detected are used for determining the RSSI.

8. The remote transponder device of claim 7, further comprising:
a processing module coupled to receive the data recovered from the data channels, wherein the processing module can be placed in a low power state;
a high frequency (UHF) transmitter coupled to processing module, wherein the UHF transmitter can be placed in a low power state; and
wake selection logic coupled to the pattern detection logic, the wake selection logic configured to assert a wakeup signal to wake up the processing module and the UHF transmitter only when the wakeup pattern sequence is detected on at least one of the plurality of channel signals.

9. The remote transponder device of claim 8, wherein the plurality of LF receiving antennas comprise three orthogonally oriented antennas.

10. The remote transponder device of claim 9 being a passive entry key for an automobile.

11. A passive entry system comprising:
means for receiving an electromagnetic interrogation signal from an interrogation antenna by a remote transponder, wherein the interrogation signal includes a wakeup pattern data sequence;
means for generating a plurality of channel signals within the remote transponder from a corresponding plurality of antennas in response to the electromagnetic interrogation signal;
means for performing bit detection on each of the plurality of channel signals to detect the wakeup pattern sequence; and
means for determining a received signal strength indicator (RSSI) of the interrogation signal using the plurality of channel signals, wherein only channel signals on which a valid wakeup pattern sequence is detected are used for determining the RSSI.

12. The passive entry system of claim 11, further comprising means for asserting a wakeup signal to wake up a processing module in the remote transponder only when the wakeup pattern sequence is detected on at least one of the plurality of channel signals.

13. The passive entry system of claim 11, wherein the means for receiving an electromagnetic interrogation signal comprise three orthogonally oriented antennas.
